(19) United States
(12) Patent Application Publication
(10) Pub. No.: US 2018/0333657 A1
(43) Pub. Date: Nov. 22, 2018

(54) DETECTION OF CONTENTS OF A SAND SEPARATOR USING RADIATION

(71) Applicant: SABLE SAND SOLUTIONS INC., Calgary (CA)

(72) Inventor: Bruce LYON, Airdrie (CA)

(73) Assignee: SABLE SAND SOLUTIONS INC., Calgary (CA)

(21) Appl. No.: 15/977,714

(22) Filed: May 11, 2018

Related U.S. Application Data
(60) Provisional application No. 62/507,625, filed on May 17, 2017.

(51) Int. Cl. B01D 19/00; B01D 21/00; G01F 23/288

(52) U.S. Cl. CPC B01D 19/0042; B01D 2221/04; G01F 23/2885; B01D 21/0012

(57) ABSTRACT

Apparatus and methods of measuring the level of materials within a sand separator are disclosed. Embodiments include mounting the source and detector on an expandable band to facilitate moving the detector between separators, and embodiments in which the detector is configured to provide a response when the level exceeds a threshold level. The response may include an audio-visual alert or controlling dumping of sand from the separator.

### CROSS-REFERENCE TO RELATED APPLICATIONS

This application claims priority to U.S. Provisional Patent Application No. 62/507,625 filed on May 17, 2017. U.S. application No. 62/507,625 is hereby incorporated by reference in its entirety.

### FIELD OF THE INVENTION

The invention relates to methods and apparatus for determining the level of contents (e.g. sand, water, solid and liquid hydrocarbons) within a sand separator. More specifically, the invention relates determining the level of contents using radiation.

### BACKGROUND OF THE INVENTION

Natural gas is a naturally occurring hydrocarbon gas mixture consisting primarily of methane, up to 20% other hydrocarbons as well as varying amounts of impurities such as carbon dioxide. Natural gas is widely used as an energy source and it is generally found in deep underground natural rock formations or associated with other hydrocarbon reservoirs. The underground rock formations or subsurface reservoirs of hydrocarbons typically consist of a porous layer, such as limestone and sand, overlaid by a nonporous layer. The porous layer forms a reservoir in which hydrocarbons are able to collect. To recover hydrocarbons, wells are drilled from the surface of the earth through the nonporous layers overlying the reservoir to tap into the reservoir and allow the hydrocarbons to flow from the porous formation into the well. The hydrocarbons, including oil and natural gas, are then recovered at the earth's surface where they undergo further processing.

Recovering natural gas is often not as straightforward as it appears, as the gas may not readily flow from the reservoir into the well bore as a result of a variety of factors including formation characteristics and pressures. As such, as is well known in order to increase gas flow and recovery, many methods are employed as means of increasing natural gas production including horizontal drilling and hydraulic fracturing, or “fracing”. Horizontal drilling, as opposed to vertical drilling, involves drilling a well more or less horizontally through a reservoir to increase the exposure of the formation to the wellbore, thereby decreasing the distance the gas must travel to the wellbore.

Hydraulic fracturing involves pumping high pressure fluids and sand into the reservoir in order to open up the formation by fracturing the rock in the reservoir. After the pressure is released, the sand remains in the fracture to create a higher permeability flow path towards the well.

Horizontal drilling and hydraulic fracturing are generally effective at increasing the recovery of hydrocarbons, however they also create additional challenges that must be dealt with. Specifically, large quantities of fluid, sand and other additives are introduced into the formation and mixed with the hydrocarbons during fracturing. After the fracing stimulation of the well, introduced fracing sand and naturally occurring reservoir fines or sand and/or fracing sands can be produced back into the horizontal well along with any remaining fluids, natural gas and other reservoir fluids. This particulate is produced to the surface and can cause plugging and/or erosion of surface equipment and pipelines.

To remove sand from natural gas at the surface, apparatuses commonly referred to as sand separators are used. Typically a sand separator comprises a vessel with an inlet port and a gas outlet port on the upper part of the vessel, and a drain at the bottom of the vessel. In addition, this vessel may or may not include secondary filters. The inside of the vessel is formatted such that when a high pressure, high velocity production stream from a well flows into the vessel through the inlet port, it experiences a large drop in velocity, causing the natural gas to separate from the water and sand. The vertical divider forces the fluid and sand down towards the drain, while the gas rises back up around the divider and exits through the gas outlet port. An example of a past sand separator is described in U.S. Pat. No. 7,785,400.

U.S. Pat. No. 9,616,431 describes an apparatus and method for separating a natural gas production stream from hydrocarbon well operations into a gas component and a sand and liquid component. More specifically, a sand separator comprises a cylindrical body, a production stream inlet port, a gas outlet port and a solid and liquid drain port. The cylindrical body has an inner cavity with an inner cone having one-way gas vents and a stationary auger wrapped around the inner cone. The production stream inlet port includes a pipe having a curved tip that directs the production stream into the body and around the inner cone and stationary auger, causing the production stream to slow down and the components to separate.

An issue with sand separators is determining when to dump or clean the unit out. If you fill the unit above capacity, sand may carry over into the gas stream which would negate any usefulness of the unit.

Currently, the ways in which the sand is measured include physically measuring the amount of sand coming in and setting a time limit to clean the separator. This method is time consuming and difficult as flow parameters are usually very dynamic.

Another means is measuring the pressure differential through the separator and then dumping the sand when the pressure differential exceeds a threshold.

Weigh scales have also been used to measure the amount of sand in the unit, but as with the other technologies it depends of the flow parameters (water/gas/oil/solids) and other variables including rain, mud etc. that can collect on the separator.

### SUMMARY OF THE INVENTION

According to a first aspect, there is provided a sand separator comprising:

a body having an upper end, a lower end, a body wall and an inner cavity;

an inlet pipe having a first and second end and extending through the body wall, wherein the first end is on the outside of the body and the second end extends to within the inner cavity;

a gas outlet port on the upper end of the body;

a drain near the lower end of the body;

a detector comprising:
a radiation source mounted on the outside of the body;
a radiation monitor mounted opposed to the source, the radiation monitor configured to detect radiation emitted by the radiation source after it has passed through the inner cavity;

wherein the detector is configured to monitor the detected radiation and provide a response in reaction to the detected radiation corresponding to a sand level exceeding a predetermined threshold.

It will be appreciated that the radiation monitor is mounted opposed to the source in order to ensure that the radiation emitted by the source and detected by the radiation monitor passes through the inner cavity of the body so that it will pass through the contents of the body (e.g. sand, water, oil, gas). Opposed may encompass diametrically opposed so that the detected radiation passes substantially through the middle of the body.

The predetermined threshold may be defined in terms of radiation (e.g. absolute or relative amount of radiation detected by the monitor) or in terms of a calculated level of sand.

The response may comprise providing an alert. The response may comprise a visual and/or an audio response. The response may comprise controlling flow of material entering the body through the inlet pipe. The response may comprise opening the drain to remove sand from the body.

The radiation source and the radiation monitor may be mounted on an expandable band. This may help ensure that the radiation source and the radiation monitor are easily aligned when the detector is moved from one separator to another.

Mounted may encompass rigidly mounted. Mounted may be considered to encompass fixing, affixing or attaching to the band (e.g. so that there is limited vertical and/or horizontal movement when the band is tightened onto the separator). The mounting may be permanent (e.g. welded or riveted) or repeatedly reversible. As an example of a repeatedly reversible mount, the source may have connectors which mate with corresponding connectors on the band so that if the source were removed (e.g. for transport), the source would be in the same position on the band when the connectors were reconnected.

The body wall may be formed from steel. The body wall may be more than 2 inches thick.

The sand separator may be a high pressure sand separator. High pressure in this context may correspond to 3,000 psig to 10,000 psig (20-70 MPa), and/or greater than 10,000 psig (70 MPa).

According to a further aspect, there is provided a detector for a sand separator, the detector comprising:

an expandable band configured to surround the circumference of the sand separator;

a radiation source mounted on the band;

a radiation monitor mounted on an opposed point on the band, the radiation monitor configured to detect radiation emitted by the radiation source after it has passed through the sand separator.

The radiation source may be configured to emit radiation with a wavelength of less than 10 picometers. The radiation source may be configured to emit radiation with energy greater than or equal to 1 MeV. The radiation source may be configured to emit radiation with energy between 500 keV and 1 MeV.

The radiation source may comprise a caesium 137 source.

The radiation source is configured to emit radiation at over 2 curie (e.g. greater than 3 Ci).

The radiation monitor may comprise a scintillation detector. The radiation monitor may comprise one or more of: a Geiger-Müller tube; a ionization chamber; a proportional counter; and a semiconductor detector.

The band may be made of steel.

According to a further aspect, there is provided a method of using a sand separator of claim 1-8 for determining the level of material within a sand separator, the method comprising:

determining the rate of radiation received at the radiation monitor;

determining the level of material within the sand separator based on the determined radiation rate and a predetermined calibration curve; and

enabling the response when the determined level of material has exceeded a predetermined threshold.

The radiation source may be a nuclear radiation source. A nuclear radiation source may comprise a radioactive source such as iridium-192, caesium-137 or radium-226, or cobalt-60. The radiation source may be an x-ray or gamma ray source. The radiation source may be a beta radiation source. X-rays may be produced by an x-ray tube. The radiation monitor may be sensitive to beta radiation and/or x-rays and/or gamma rays.

The radiation source may be housed in a housing which comprises shielding configured to direct radiation through the vessel or body to which the detector is mounted.

The radiation source housing may comprise a shutter which can be closed. When the shutter is closed the housing may substantially prevent radiation from escaping the housing. This may help reduce exposure to workers while the detector is moved between sand separators. The shutter may comprise a lock to allow the shutter to be locked in a closed position.

The radiation source may be a fan beam source or a strip source. Strips sources emit radiation evenly along the length of an elongate source. This radiation is directed through the vessel and may be detected by a suitably aligned elongate detector. A fan beam source emits radiation in a wide range of angles along a first dimension (e.g. 30-60°) and a narrower range of angles in the dimension perpendicular to the first dimension (e.g. 12° or less). This means that the beam has a fan shape.

The detector may be configured to allow it to be retrofitted to various sand separators.

The radiation detector may be configured to detect radiation from a wide range of angles from the source (e.g. greater than 30° or greater than 45°). The radiation detector may be configured to emit radiation in a narrow vertical band towards the radiation monitor. The radiation source may be located towards the top of the separator body. The radiation source may be configured to emit radiation horizontally and downwardly through the separator body towards the radiation monitor.

The detector may be configured to be sensitive only around the threshold level of sand. That is, the detector may be configured to measure the attenuation across a narrow vertical angle range (e.g. less than 12°, less than 10°, less than 5° or less than 2.5°) within the body of the sand separator, the narrow band corresponding to the threshold level of sand within the separator. The narrow angle range may be centered on the horizontal. The detector may be configured to detect a narrow range by collimating the source (e.g. using a beam limiting device) and/or reducing the size of the sensitive area of the radiation monitor.

The detector may comprise multiple radiation sources. The detector may comprise multiple radiation monitors.

A separator for separating solid and liquid components from gas components in a hydrocarbon production stream may comprise: a cylindrical body having an upper end, a lower end, a body wall and an inner cavity; an inlet pipe having a first and second end and extending through the body wall, wherein the first end is on the outside of the body and the second end extends to within the inner cavity; a gas outlet port on the upper end of the body; a drain near the lower end of the body; and an inner vessel fastened in the inner cavity of the body, the inner vessel having a vessel wall, a vessel cavity, and a plurality of openings in the vessel wall wherein solid and liquid components of a hydrocarbon production stream entering the cylindrical body are preferentially directed to the drain and gas components are preferentially directed to the gas outlet port.

The inner vessel may be cone-shaped having a wider upper end in relation to a narrower lower end. The threshold level of sand may be at or around the bottom of the cone-shaped inner vessel.

A plurality of openings in the inner vessel wall may include one-way gas vents. Each gas vent may include a cap partially covering each opening. The threshold level of sand may be just below the level of the lowest opening within the inner vessel.

The separator may include a stationary auger operatively connected to an inner surface of the body wall and operatively positioned between the inner vessel and the inner surface of the body wall. The auger may be separated from the inner vessel by a gap and/or has an inwardly and downwardly sloping surface.

The separator may include a wear plate fastened to the body wall in the inner cavity adjacent the second end of the inlet pipe.

The inner vessel may comprise at least one inwardly projecting ledge extending around the vessel wall within the vessel cavity.

Also disclosed is a method for separating solid and liquid components from gas components in a hydrocarbon production stream may comprise the steps: a) transporting the production stream into a cylindrical vessel; b) creating an initial drop in velocity of the production stream; c) directing the production stream flow around an inner cavity of the cylindrical vessel; d) collecting the gas components from the production stream at a top end of the vessel; and e) collecting the sand and liquid components at a bottom end of the vessel.

Corresponding methods are also disclosed. For example according to an aspect of the present disclosure, there is provided a method of aligning a source and a detector for detecting the level of materials within a sand separator comprising: arranging a radiation source and a radiation detector on an expandable band.

Also disclosed is a method of using a level detector (e.g. as described above) to determine the level of material within a sand separator comprising:

determining the rate of radiation received at the radiation monitor;

determining the level of material within the sand separator based on the determined radiation rate and a predetermined calibration curve; and

providing a response when the determined level of material has exceeded a predetermined threshold.

One or more of the methods described above may be enabled using a computer program. For example, the level monitor may comprise a controller, the controller comprising a processor, memory and a computer program stored on the memory. When the computer program is run on the processor, the steps of the method may be carried out.

The controller may comprise a data-logger. The controller may comprise a user interface for providing the response (e.g. an audio-visual response). The controller may be configured to control a valve for dumping the solid and liquid contents of the separator.

The processor may comprise, for example, a central processing unit, a microprocessor, an application-specific integrated circuit or ASIC or a multicore processor. The memory may comprise, for example, flash memory, a hard-drive, volatile memory. The computer program may be stored on a non-transitory medium such as a CD. The computer program may be configured, when run on a computer, to implement methods and processes disclosed herein.

### BRIEF DESCRIPTION OF THE DRAWINGS

The invention is described with reference to the accompanying figures in which:

FIG. 1 is a front perspective cutaway view of a sand separator in accordance with one embodiment;

FIG. 2 is a front cutaway view of a sand separator in accordance with one embodiment;

FIG. 3 is a front view of a sand separator and level detector in accordance with one embodiment;

FIG. 4 is a top cross-sectional view of the sand separator and level detector taken at line C4-4′ of FIG. 2 in accordance with one embodiment of the invention; and

FIG. 5 is a perspective view of one embodiment of a level detector;

FIG. 6 is a schematic cross-section view of the detector of FIG. 5 mounted on a sand separator;

FIG. 7 is a perspective view of a source mount;

FIG. 8 is a front view of the source mount of FIG. 7;

FIG. 9 is a graph showing experimental results of how the signal ratio diminishes with fill level;

FIG. 10 is a schematic cross-section view of a further detector with multiple radiation monitors mounted on a sand separator; and

FIG. 11 is a schematic cross-section view of a further detector mounted on a sand separator.

### DETAILED DESCRIPTION OF THE INVENTION

High pressure sand separators have been used in the oil and gas industry for many years. As horizontal wells have been drilled deeper and longer, and stimulated with more and larger fracs, handling the sand that is returned has become a significant safety issue.

There are many types of sand separators available but one of the problems encountered is how to determine when to dump or clean the unit out. If the unit is filled above capacity you will invariably have sand carry over which would negate any usefulness of the unit. This is particularly important in embodiments in which gas is vented from the inner separation cavity via openings on an interior surface (e.g. in an inner vessel) because it is difficult to directly position detectors at those openings. Therefore, detecting the level of sand in the separator is important to help ensure that sand does not pass into the gas openings.

Furthermore, the inventors have realized that after a separator has been operating on a particular well for some time, it may be possible to predict the quantity of sand that that well is likely to produce. Therefore, once sand production has been monitored over a period of time, it may be possible to predict future sand production thereby mitigating the need for active monitoring.

The inventors have therefore identified a need for a robust level-detector which can be moved from separator to separator. They have recognized that using a level detector with a radiation source and radiation monitor may be advantageous because all of the components necessary to determine the level of material (e.g. sand and/or water) within the separator may be mounted on the exterior of the sand separator thereby facilitating exchange. To enable moving the level detector it would be advantageous if the alignment of the source and detector was easy to reproduce.

Current methods of measuring the level of sand within the separator include physically measuring the amount of sand coming in and setting a time limit to clean the separator. This method may be time consuming and difficult as flow parameters are usually very dynamic.

Another means is measuring the pressure differential through the separator and deciding when to dumping based on the measured pressure differential. As mentioned above, waiting until the pressure differential is high (e.g. due to sand clogging) may be too late as sand may have already gone through the gas openings to damage equipment downstream of the separator. In some cases, the pressure differential is accentuated by placing a screen within the body of the separator which leads to a large increase in pressure when the sand reaches the level of the screen. This requires parts of the level detector to be placed inside the unit which means that it is more difficult to switch the level detector between separators.

Weigh scales have also been used to measure the amount of sand in the unit, but as with the other technologies it depends of the flow parameters (water/gas/oil/solids) and other variables including rain, mud etc. that can collect on the outside of the separator (e.g. snow fall can increase the apparent weight of the separator). In addition, vibrations, flow or turbulence within the separator can cause the apparent weight of the separator to change. In addition, measuring the weight of the separator requires the separator to be supported on or by scales for weighing. This makes the level detector difficult to move between separators as it may require the separator itself to be moved.

Another emerging issue around sand separators relates to trying to understand the way the sand is produced (i.e. Slug flow, consistent flow, trends). Using a contact-type measurement unit such as flappers or tuning forks is difficult due to the erosive properties of the production flow. Other types of level management such as radar and sonic detection have faced problems because of issues arising from the high pressure system (thickness of the metal shell etc.).

Therefore, desirable characteristics of a sand level detector include that the detector include:
robust;
can operate in conjunction with high-pressure vessels (e.g. the bodies of high-pressure sand separators);
easily moveable from one separator unit to another (ideally all components are mounted to the exterior of the separator and not supporting the separator);
not affected by vibrations and turbulence within the separator;
is insensitive to events or material outside the separator (e.g. mud and snow accumulation); and
can be easily aligned on the new separator.

With reference to the figures, a sand separator 10 in conjunction with a level detector 100 is described. The sand separator generally comprises a vessel 12 having an inlet pipe 20, a gas outlet pipe 30 and a drain 40. The interior of the sand separator comprises a collecting plate 46, an inner cone 50, a wear plate 60, and an auger 70. In this case, the sand separator corresponds to that described in U.S. Pat. No. 9,616,431.

It will be appreciated that the level detector may be used in conjunction with any sand separator having a body having an upper end, a lower end, a body wall and an inner cavity; an inlet pipe having a first and second end and extending through the body wall, wherein the first end is on the outside of the body and the second end extends to within the inner cavity; a gas outlet port on the upper end of the body; and a drain near the lower end of the body.

The sand separator and detector are described herein with typical dimensions and as being manufactured from specific materials. It is understood, however, that variations in the dimensions and materials may be made while achieving the objectives of the invention as understood by those skilled in the art. It will be appreciated that the detector may be used with other sand separators.

### Vessel

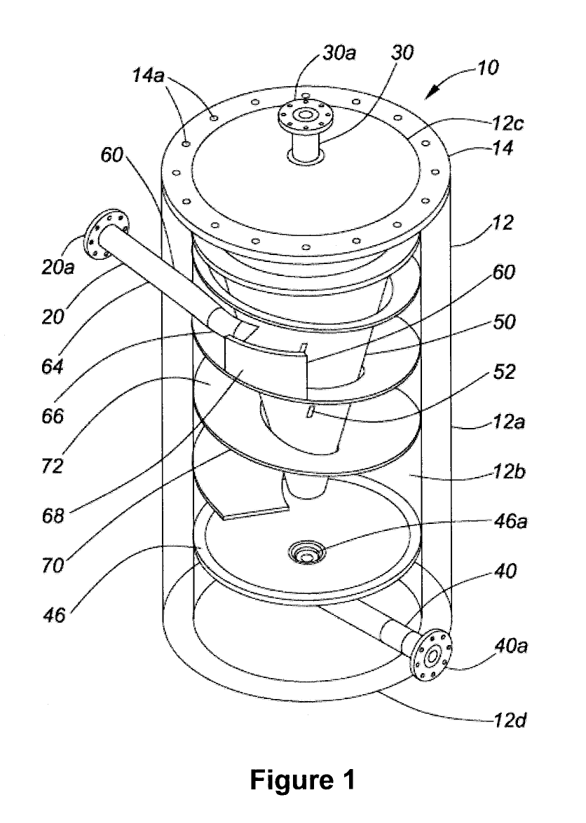

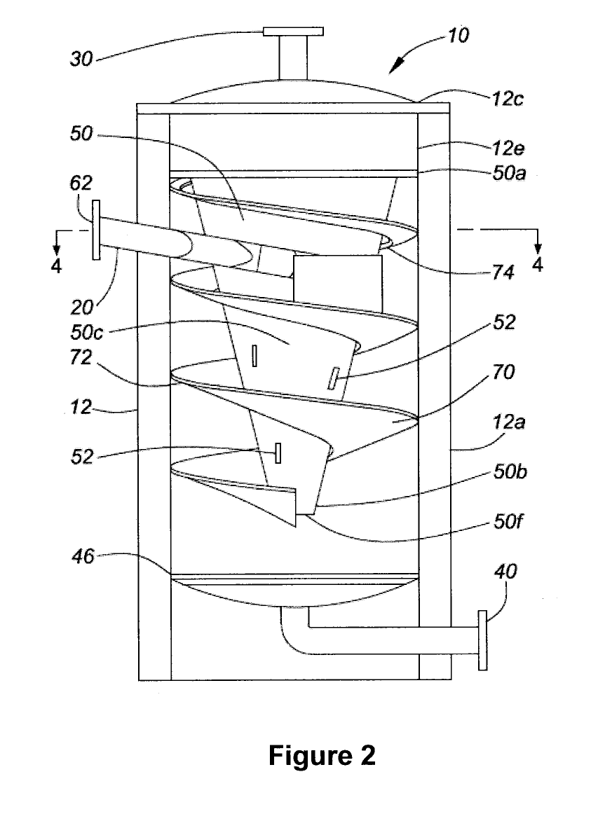

Referring to FIGS. 1 and 2, the vessel 12 is preferably a cylindrical shaped hollow vessel having an outer wall 12a, inner cavity 12b, top end 12c, bottom end 12d. The external dimensions of the vessel are typically about 3 to 6 feet in diameter and 6 to 10 feet in height. The outer wall 12a, top end 12c and bottom end 12d of the vessel are fabricated from rolled steel and are of sufficient thickness to accommodate an internal pressure of up to 5000 psi. The thickness of the wall in this case is 2 inches. Although the thickness of the walls significantly shield the nuclear radiation, by using more intense source (e.g. a 3 curie Cs-137 in this case) it may still be possible to make a measurement of the level of sand within the separator.

The top end 12c of the vessel has a flange 14 with a plurality of bolt holes 14a for attachment to a pipe or other device. The bottom end 12d of the vessel is secured to a stand or legs for support (not shown).

The vessel 12 comprises three ports from the outside of the sand separator to the inner cavity 12b: the inlet pipe 20 located in the top half of the outer wall 12a; the gas outlet pipe 30 located on the top end 12c of the vessel; and the drain 40 located on the bottom end 12d of the vessel. Each pipe port is moveable between an open and closed position and has a flange 20a, 30a, and 40a for fastening to complimentary pipes, hoses or other conveyance devices.

### Inner Cone

Referring to FIGS. 2, 3 and 4, the inner cone 50 is located in the inner cavity 12b of the vessel and comprises an upper end 50a, a lower end 50b, a cone wall 50c and a cone cavity 50d. The upper end 50a of the cone is connected to an inner surface 12e of the top end 12c of the vessel. There is a continuous path between the cone cavity 50d and the gas outlet pipe 30. The lower end 50b of the cone has an opening 50f to allow sand and liquid to drain from the cone cavity.

The cone wall 50c includes a plurality of reverse entry gas vents 52 that allow gases to flow into the cone cavity 50d while obstructing the flow of particulates from entering the cone cavity 50d. The gas vents 52 preferably include a cap 52a covering each vent opening such that a change in direction is required for gas/solid/liquid to flow through each gas vent opening. In addition, each cap is preferably positioned in downwardly angled parallel rows in line with the angle of the inlet pipe 20. As these gas vents are positioned within the inner cavity they may not be easily monitored directly.

On an inner surface 50g of the cone wall 50c, there is a first and second circular ledge 54a, 54b that protrudes inwardly from the inner surface of the cone wall and extends around the inner circumference of the cone wall slightly above a row of gas vents.

The threshold of level of sand in this case may be around the tip of the inner cone.

### Collecting Plate

Referring to FIGS. 1 and 2, the collecting plate 46 is located near the bottom end of the interior of the vessel 12, spanning across the inner cavity to collect the sand particles and liquids that drop out of the production stream and direct them towards a channel 46a in the middle of the collecting plate. The channel connects to the drain 40 to allow the collected stream to flow out the vessel.

### Inlet Pipe

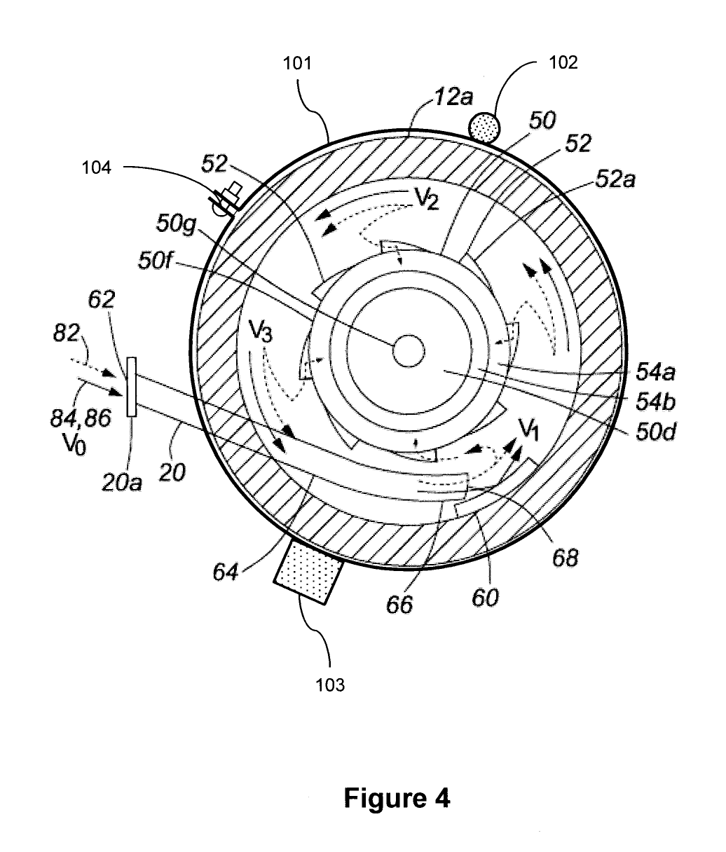

Referring to FIG. 4, the inlet pipe 20 comprises a first opening 62, a body 64 having a curved tip 66 and a second opening 68. A wear plate 60 is fastened to the inner surface of the vessel near the curved tip 66 of the inlet pipe. The pipe body 64 is preferably positioned at a slight downward angle of approximately 10 degrees to the horizontal.

The body 64 of the inlet pipe is preferably made of a hard metal to withstand high levels of abrasion from the production stream 80 colliding with the inner walls of the body. The wear plate 60 protects the vessel wall from abrasion due to high-pressure high-speed particles hitting it continuously during use. When the wear plate is abraded to a certain extent, it can be removed and replaced quickly, thereby saving the whole vessel from being replaced and thereby saving time, money and labor.

As noted above, the flow from the inlet pipe may be sporadic and dynamically change with time. For example, the rate and proportion of sand production from the well may not be constant.

### Auger

Referring to FIGS. 1 and 2, the auger 70 is located around the inner cone 50 in the inner cavity 12b of the vessel 12. The auger 70 is stationary and comprises a surface 72 attached to the inner surface 12e of the vessel that spirals around the inner cone 50 and gets progressively wider from top to bottom, with a gap 74 located between the auger and inner cone.

### Level Detector

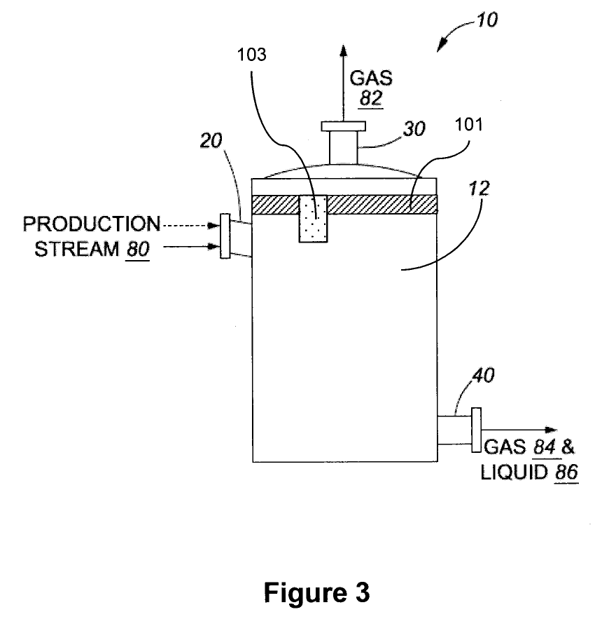

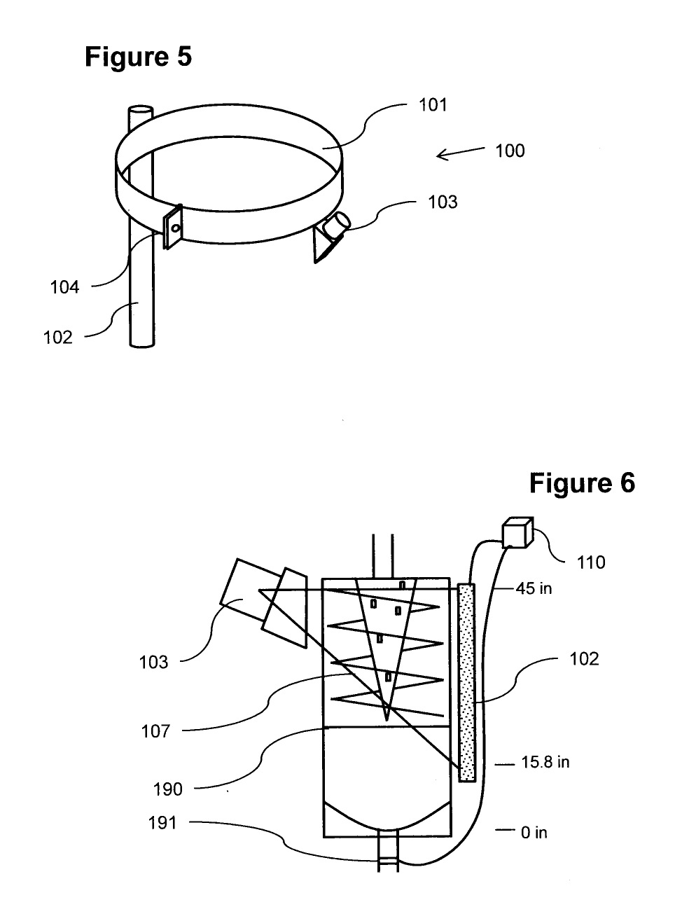

FIGS. 3 and 4 show it in conjunction with the sand separator described above. FIG. 5 shows the level detector in isolation. FIG. 6 shows the principle of operation of the detector.

The detector 100 in this case comprises:

an expandable band 101 configured to surround the circumference of the sand separator;

a radiation source 103 mounted on the band;

an elongate radiation monitor 102 mounted on a diametrically opposed point on the band, the elongate radiation monitor configured to detect radiation emitted by the radiation source after it has passed through the sand separator.

The band 101 in this case is formed from steel and is expandable to by having a split forming two flanges 104 which can be tightened via one or more bolts connecting the two flanges. Other embodiments may use other methods of expanding and contracting the band. For example a fabric band may be tightened using ratchet straps. Some embodiments may be configured to have two tightening mechanisms, one on either side of the band to allow the length of the band to be varied equally on either side of the detector to help ensure that the detector can be positioned more exactly opposite the source on different diameter separators.

To move the level detector to another separator, the expandable band 101 is loosened (or opened) which allows all of the components of the detector system to be removed from the sand separator. The band 101 is then positioned on the next separator and tightened which automatically helps align the source 103 and radiation monitor 102.

In this case, the strap-on system 100 uses a Cs 137, 3 Ci nuclear source with a radiation monitor 102 configured to monitoring along a 3 foot span on the lower end of the separator below the directional rotation cone that separates the solids from the production stream.

The radiation monitor 102 in this case is a PVT scintillation detector to measure the radiation reaching the detector from the source 103. The radiation monitor 102 also, in this case, has a photomultiplier tube with associated electronics. When gamma radiation strikes the scintillation material in the PVT scintillation detector, small flashes of light are emitted. That is, the radiation monitor is sensitive to gamma radiation. The photomultiplier tube and associated detector electronics convert the light pulses into electrical pulses that are processed by electronics in the detector of the integrated unit or transmitter to determine the process material level and related measurement values.

As the level of the process material increases, more gamma radiation is attenuated by the process material, which allows fewer gamma rays to reach the detector generating fewer light pulses. Therefore fewer counts are detected as the level of solids and liquids rises.

The detector and source may be procured commercially (e.g. from Thermo Fisher Scientific™).

The radiation monitor is connected to a controller 110 that records the sand level. The controller, in this case, comprises a data-logger and a user interface for providing an audio-visual response. It is then connected to a light that lets the operator know when the sand level exceeds a predetermined threshold. In this case, the response also comprises automatically dumping sand from the separator. To facilitate this, the controller 110 is connected to a valve 191 located within the drain of the sand separator. The valve is configured to open in response to the controller sending an open command. The open command is initiated by the controller when the detected radiation corresponds to a sand level exceeding a predetermined threshold.

In this case, the controller is connected to the radiation monitor and to the valve using a wired connection. Other embodiments of the controller may be configured to communicate wirelessly (e.g. with the radiation monitor, the valve actuator and/or a remote computer or server).

The data logger may comprise or be connected to a controller. The data-logger is configured to track and report the level of sand inside the separator. For example, this could be used to track and display (e.g. on a screen) sand production over time. The controller may also be mounted on the expandable band.

The detector in this case is calibrated to give us a solid (e.g. sand) level as opposed to liquid level. In this case, the detector is also configured to determine the rate that the unit is filling up (e.g. with solids). Other embodiments may be calibrated to provide liquid levels. Other detector embodiments may be calibrated to give specific densities at a single point or level.

To determine the level of sand, the data-logger 110 is configured to measure the rate of radiation impinging on the radiation monitor (e.g. by measuring the number of scintillation counts over a particular period of time). The rate may then be mapped to a fill level based on a predetermined calibration curve. It will be appreciated that in a multi-phase system, the level of the different phases can be estimated from a single rate determination if the attenuation factor of the different phases is significantly different. In this case gas, water and sand have significantly different attenuation factors as their densities are significantly different. For example, water has a density of 1 g/cc; sand has a density of 2.65 g/cc; and natural gas has a density of 0.18 g/cc at 3,000 psi.

Furthermore, as shown in FIG. 6, because the radiation 107 is, in this case, distributed though the body at a range of angles, a particular layer of sand with a particular mass (for example) will change the attenuation of the source differently if it is positioned at a different height within the body. Therefore, as sand will gather at the bottom (due to gravity) and water on top (and between sand grains), the attenuation of the radiation may be modelled based on the position of the materials as sand and water levels 190 build up from the bottom.

In another embodiment, the detector is connected to the sand outlet and is configured to automatically dump the sand when the level is determined to exceed a predetermined threshold. For example, a spring loaded actuator may be placed on the choke and a valve on the dump system and will be able to fully automate the dump sequence. This may save time and money whilst also allowing the separator to be deployed safely on remote sites.

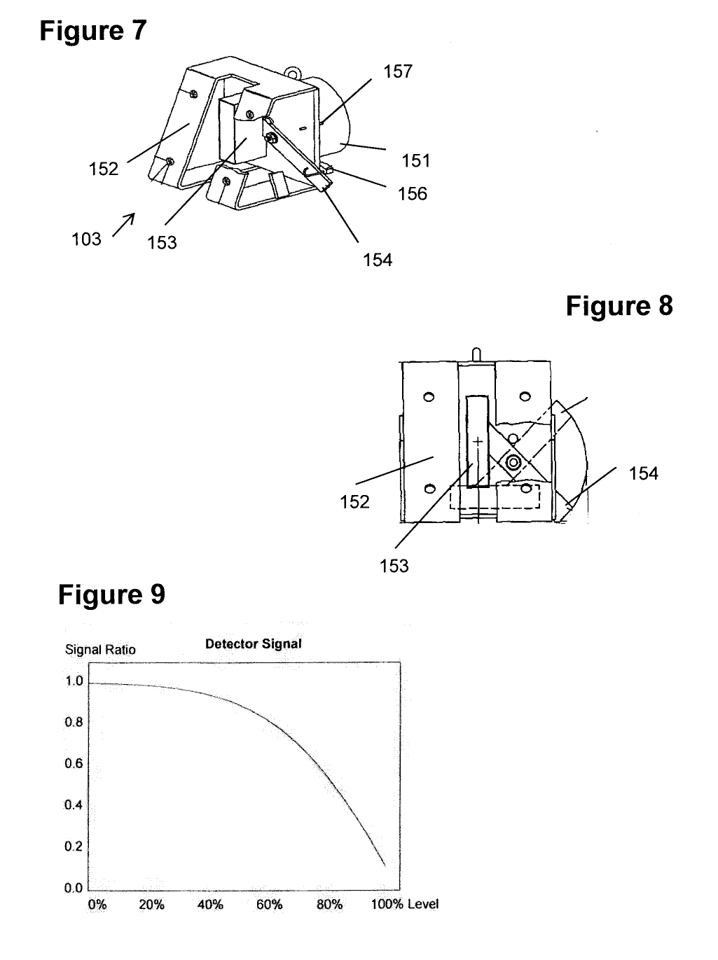

FIGS. 7 and 8 show an embodiment of a mount 103 for the radiation source (Thermo Fisher™ Model 5208 source housing). In this case, the source is housed in a lead-cased steel housing 151. The mount 103 comprises an angled surface 152 such that when the angled surface is mounted on the surface of a vessel, the radiation enters the vessel at a range of vertical angles (in this case around 45°; other embodiments may have an angle range of between 30°-60°) wherein one end of the range corresponds to around normal to the surface of the vessel. More information on the Thermo Fisher™ Model 5208 mount can be found in the LevelPRO, Continuous Gamma Level System Installation Guide, P/N 717760, Revision H (URL: tools.thermofisher.com/content/sfs/manuals/D01394˜.pdf).

A Cesium (Cs-137) radioisotope source is used to provide the gamma radiation field for this application. A Cobalt (Co-60) source may also be used for applications requiring a higher energy source— typically those with very thick-walled vessels. In this case, the source capsule secures the radioisotope inside a glass matrix and then double encapsulates the glass in a pair of sealed stainless steel capsules, ensuring extreme resistant to vibration and mechanical shock.

The source housing 157, a lead-filled, welded steel housing, further encloses the source capsule. A shaped opening in the lead shielding directs the gamma radiation beam through the process material towards the detector. For most level applications, the source is designed to produce a fan beam. Outside of the beam path, the energy emitted from the source head is very low and well within prescribed limits.

In this case, the mount comprises a shutter which is a moveable beam block 153. The shutter can be opened or closed by moving a lever 154. The lever can be locked in a closed position 157 (as shown in FIG. 7 and in solid lines in FIG. 8) or in an open position (shown in dotted lines in FIG. 8) using a padlock 156.

### Separation of Phases

As shown in FIG. 4, the production stream comprising gases 82 (dotted line), sand and other particulate matter 84, and liquids 86 (solid line), enters the vessel through the first opening 62 of the inlet pipe 20. The production stream enters the vessel with highly variable velocities that are determined by the gas production volumes and pressures, shown as V₀ in FIG. 4. The production stream flows through the body 64 of the pipe, around the curved tip 66 of the inlet, out the second opening 68, and collides with the wear plate 60. As the production stream exits the second opening, the volume available for the production stream is greatly expanded from the unit volume of the inlet pipe, thereby causing a large initial drop in the velocity of the production stream (designated as V₁). For example, high pressure fluids in a typical 2 inch diameter inlet pipe may enter the vessel at a location having a nominal 21 inch diameter which thereby results in an approximate 110 fold change in cross-sectional area at the point of transition which similarly results in a 110 fold change in flow velocity of the production stream.

Upon exiting the second opening and after impacting the wear plate, initially the lighter gas fractions due to their lower density and lower centrifugal forces acting on the lighter fractions will flow towards the gas vents 52. The heaver particles of sand and liquid, shown by the solid arrows, and the heavier gas fractions will be propelled around the inner walls of the vessel, where they continue to slow to velocities V₂ and V₃. Moreover, these fractions will also spiral downwards towards the bottom of the vessel due to impacting with the auger. The downward spiral direction is initiated by the downward angle and curved tip of the inlet pipe. Continued contact with the auger 70 continues to slow and direct the stream downwards as the stream spirals around the ledge 72 of the auger thus reducing the centrifugal forces on the gas/liquid fractions. The lower centrifugal forces on the gas fractions will continue to enable the gas fraction to enter the cone through gas vents 52 while the slowing liquids and solids will drop from suspension. Importantly, the gap 74 between the auger ledge and the inner cone as well as the inward slope of the auger prevents droplets/particles from collecting and/or stalling on the auger ledge and allows them to fall downwards towards the collector plate 46. The auger also minimizes the formation of a vortex in the vessel that might otherwise form if the velocity of gas/liquids is not slowed gradually.

When the gases flow through the gas vents 52 into the cone cavity 50d, depending on the relative velocities, some sand 84 and liquid 86 particles may not drop out of the production stream 80 and will flow with the gas through the gas vents. When the gas, sand and liquid stream flows through the gas vents, the stream will initially collide with the underside of the first and second ledge 54a, 54b, thereby creating a low velocity zone that causes substantially all of the carried-over sand and liquid particles to drop out of the gas stream and thereby fall down the cone where they drop or flow out of the opening 50f in the bottom of the cone onto the collecting plate 46. In contrast, the gas stream readily flows around the first and second ledge 54a, 54b, to exit the gas outlet pipe 30 at the top end of the vessel 12.

When the solid/liquid phases reach the bottom of the auger or the cone opening 50f, they fall onto the collecting plate 46, flowing through the channel 46a and out the drain 40. Typically large sand particles greater than 50 μm in diameter and most of the liquids are collected. The drain may be connected to a settlement tank wherein the sand and liquid particles are further separated for disposal.

Most of the gases from the production stream exit the vessel through the gas outlet pipe 30 and may be subjected to further separation techniques, such as a filtering device, downstream from the sand separator in order to remove any finer particulate matter.

The sand separator as described typically separates approximately 91% of the particulate matter (i.e. sand) from the production stream. The remaining particulate matter is typically smaller sand particles of less than 50 μm that can be, if required, filtered out downstream. Any remaining smaller particulate are less able to either plug or erode surface equipment.

### System Advantages

The sand separator as described is able to effectively separate gas from production streams, especially high pressure, high velocity production streams that also comprise liquid and particulate phases. The gas component is mostly natural gas, whereas the liquid and particulate phases are primarily water and sand; however other solid/liquids may also be present. Production streams from the early stages of horizontal well fracturing can have initial pressures from 3000 to 5000 psi, and at times up to 10,000 psi. As such, the flow rates through typical 3 to 4 inch production lines can approach a million cubic feet per hour or more, resulting in extremely high velocities entering the vessel. Because the level detector is measuring the presence of materials between the source and detector, it is not affected by the velocities of the incoming materials.

Importantly, the subject system has several advantages over conventional sand separators by providing effective surfaces to slow each of the gas, liquid and solid phases entering the system. As such, a more effective separation can be achieved with less solid/liquid carryover. That is, the subject design allows for a more controlled release of sand from the fast moving gas as the auger will more gradually decrease the velocity of the liquid/sand entering the separator such that the flow rate of separated liquid/sand is more consistent to the outlet. This is important in addressing sudden changes in flow rates of liquid/sand that may be encountered by the device. This advantage is augmented by the presence of the level detector which prevents sand flowing over through overfilling the separator.

In addition, the replaceable removable insert reduces the abrasion caused to the vessel from the particulate matter entering the vessel at high speeds, thereby prolonging the life of the vessel. Also, the removable insert is relatively inexpensive and easy to change, requiring only minimal labor and tools, and replacement can be performed on-site as needed without having to transport the sand separator.

### Theoretical Performance Results

As noted above, the thickness of the vessel wall meant that it was important to establish that sufficient radiation would reach the detector to provide an accurate measure of the level of sand within the unit. In these theoretical calculations, the vessel parameters were defined as follows:
Vessel Inner Diameter: 18.00 in
Vessel height: 45 in
Wall thickness: 2.05 in
Wall material: 7.86 gr/cc Steel

The source (4000 mCi in 5208 Housing at an Elevation of 45.00 in) and detector were placed such that the radiation emitted from the source travels through the detector as shown in FIG. 6. The Thermo Fisher Model 5208 source housing is shown in FIGS. 7 and 8. The angle of the radiation means that the detector is sensitive to changes in radiation between the following:
minimum level: 15.8 inches (from bottom of vessel)
Maximum level: 45.0 inches (i.e. the top of the vessel, in this case)
Span: 29.2 inches

The vessel was then filled with to a two phase material while the detector was running. That is, we took an initial radiation count with the unit empty (i.e. filled with air) then we filled it with water and took a radiation count. Then we filled it with sand. The process parameters are as follows:
Upper Phase: Water (density of 1 g/cc)
Bottom phase: Sand (density of 2.65 g/cc)
Time Constant: 32 sec (this is the amount of time over which the radiation count is taken)

The detector parameters were as follows:
Detector type: 3 ft Thermo Fisher Scientific™ LevelPro ULTRA
Elevation: 45.00
Sensitive height: 38.31 in
Radiation (mR/hr): @top: 0.396 @mid: 0.152 @bot: 0.033

The theoretical results are shown in Table 1 below for various levels. FIG. 9 shows how the signal ratio varies with level.

TABLE 1
Precision Report

| % level | % Precision | Cts/sec |
|---|---|---|
| 100% | 0.08% | 2478 |
| 90% | 0.15% | 7571 |
| 80% | 0.22% | 11867 |
| 70% | 0.36% | 15209 |
| 60% | 0.58% | 17581 |
| 50% | 0.97% | 19143 |
| 40% | 1.67% | 20 111 |
| 30% | 3.00% | 20681 |
| 20% | 5.82% | 21000 |
| 10% | 11.11% | 21162 |
| 0% | 14.27% | 21218 |

The theoretical results indicate that, even with the thick walls of the pressure vessel, it is still possible to determine the level of sand within the vessel using a nuclear radiation source.

### Other Options

In other embodiments, the system may comprise multiple radiation monitors or multiple sources and radiation monitor arranged to probe different levels of the body or vessel. The use of multiple detectors may allow the radiation attenuation due to the sand to be better distinguished from the radiation attenuation due to the water.

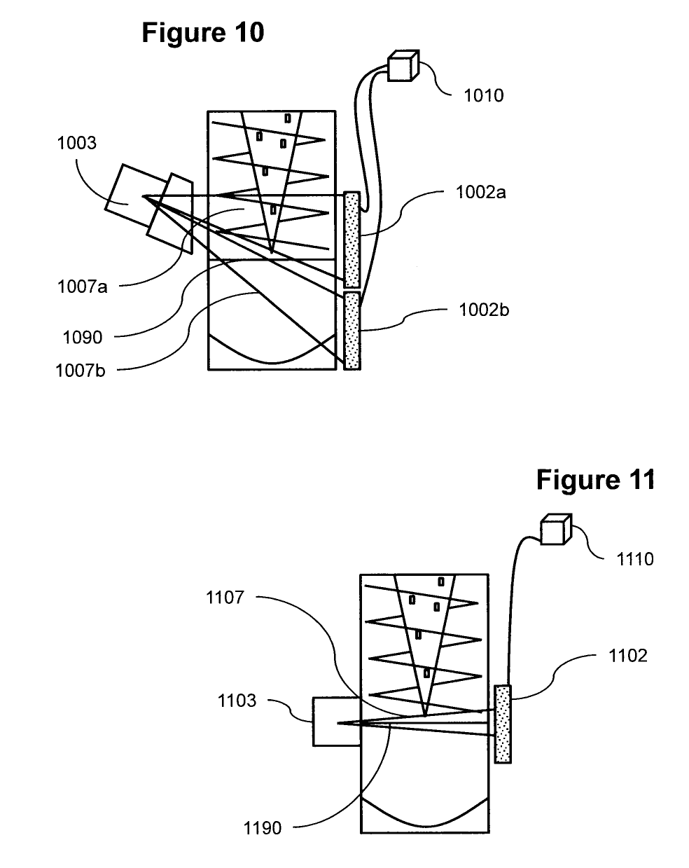

FIGS. 10 and 11 show two options. FIG. 10 shows an embodiment of a level detector comprising a radiation source 1003, aligned with two elongate scintillators 1002a, 1002b. The scintillators 1002a, 1002b are connected with a data-logger 1010 and are configured to detect different angle ranges of radiation 1007a, 1007b.

Both scintillators 1002a, 1002b are arranged such that when the level of sand is at the threshold level 1090, at least some of the radiation reaching each scintillator is passing through the sand. This may allow the threshold level of sand to be more accurately detected because it may help distinguish between larger quantities of less attenuating material (e.g. water) and smaller quantities of more attenuating materials (e.g. sand). To help align the other scintillators, each scintillator may be attached to another component in the detector (e.g. the band or another scintillator) It will be appreciated that there may be more than 2 scintillators used (e.g. a linear array).

FIG. 11 shows an alternative arrangement where the radiation source 1103 and radiation monitor 1102 are configured to measure the attenuation across a narrow angle range 1107 within the body of the sand separator, the narrow band corresponding to the threshold level 1190 of sand within the separator. That is, the source and radiation monitor are aligned with the threshold level of the sand. This embodiment is configured to provide a more binary output from the data-logger 1110. That is, as soon as material is within the narrow band, it is at or close to the threshold for emptying the separator.

Although the present invention has been described and illustrated with respect to preferred embodiments and preferred uses thereof, it is not to be so limited since modifications and changes can be made therein which are within the full, intended scope of the invention as understood by those skilled in the art.

1. A sand separator comprising:
a body having an upper end, a lower end, a body wall and an inner cavity;
an inlet pipe having a first and second end and extending through the body wall, wherein the first end is on the outside of the body and the second end extends to within the inner cavity;
a gas outlet port on the upper end of the body;
a drain near the lower end of the body;
a detector comprising:
a radiation source mounted on the outside of the body;
a radiation monitor mounted opposed to the source, the radiation monitor configured to detect radiation emitted by the radiation source after it has passed through the inner cavity;
wherein the detector is configured to monitor the detected radiation and provide a response in reaction to the detected radiation corresponding to a sand level exceeding a predetermined threshold.

2. The sand separator of claim 1, wherein the response comprises providing an alert.

3. The sand separator of claim 1, wherein the response comprises controlling flow of material entering the body through the inlet pipe.

4. The sand separator of claim 1, wherein the response comprises opening the drain to remove sand from the body.

5. The sand separator of claim 1, wherein the radiation source and the radiation monitor are mounted on an expandable band.

6. The sand separator of claim 1, wherein the body wall is formed from steel.

7. The sand separator of claim 1, wherein the body wall is at least 2 inches thick.

8. The sand separator of claim 1, wherein the sand separator is a high pressure sand separator.

9. A detector for a sand separator, the detector comprising:
an expandable band configured to surround the perimeter of the sand separator;
a radiation source mounted on the band;
a radiation monitor mounted on an opposed point on the band, the radiation monitor configured to detect radiation emitted by the radiation source after it has passed through the sand separator.

10. The detector of claim 9 wherein the radiation source is configured to emit radiation with a wavelength of less than 10 picometers.

11. The detector of claim 9 wherein the radiation source comprises a caesium 137 source.

12. The detector of claim 9 wherein the radiation source is configured to emit radiation at over 2 curie.

13. The detector of claim 9 the radiation monitor comprises a scintillation detector.

14. The detector of claim 9 wherein the radiation monitor comprises one or more of: a Geiger-Müller tube; an ionization chamber; a proportional counter; and a semiconductor detector.

15. The detector of claim 9 wherein the expandable band is made of steel.

16. A method of using a sand separator of claim 1 for determining the level of material within a sand separator, the method comprising:
determining the rate of radiation received at the radiation monitor;
determining the level of material within the sand separator based on the determined radiation rate and a predetermined calibration curve; and
enabling the response when the determined level of material has exceeded a predetermined threshold.
